(19) United States
(12) Patent Application Publication
(10) Pub. No.: US 2009/0244098 A1
(43) Pub. Date: Oct. 1, 2009

(54) METHOD AND APPARATUS FOR POLYMORPHING A PLURALITY OF SETS OF DATA

(75) Inventor: Masahiko TATEISHI, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/411,658

(22) Filed: Mar. 26, 2009

(30) Foreign Application Priority Data
Mar. 26, 2008 (JP) 2008-080930

(51) Int. Cl. G09G 5/00

(52) U.S. Cl. 345/646

(57) ABSTRACT

2^{M}-sets of model data strings (M is a positive integer and M≧2) are polymorphed. The model data strings are acquired by defining at least 2^{M}-piece coordinates being morphed in a M-dimensional model-data mapping space and making the defined model data strings correspond to the coordinates being morphed, respectively. A unit cell is set in the space. The unit cell consists of a hyper rectangular parallelepiped having 2^{M}-piece vertexes each located at the coordinates being morphed. A desired coordinate is set, as a morphing-destination coordinate, within the unit cell. The 2^{M} sets of model data strings corresponding, set by set, to the coordinates being morphed are polymorphed using weighting factors depending on distances from the respective coordinates being morphed to the morphing-destination coordinate in the unit cell. Accordingly, a string of synthesized data corresponding to the morphing-destination coordinate is produced. The string of synthesized data is outputted using an outputting device.

### CROSS-REFERENCE TO RELATED APPLICATION

This application is based on and claims the benefit of priority from earlier Japanese Patent Application No. 2008-80930 filed Mar. 26, 2008, the description of which is incorporated herein by reference.

### BACKGROUND OF THE INVENTION

1. Technical field of the Invention

The present invention relates to morphing a plurality of sets of data, such as image data, and in particular, to a method and apparatus for polymorphing three or more sets of data.

2. Related Art

Morphing has been known as one of techniques for processing images. One such an example is provided by Japanese Patent Laid-open Publication No. 2000-354517, where two images being morphed are used to obtain one morphed image. Practically, plural mutually corresponding points serving as reference points are specified between the two images, and the corresponding points on the respective images being morphed are set to be points that provide the upper and lower limits of synthesis ratios. Arbitrary intermediate synthesis ratios are then decided at respective corresponding points, and the corresponding points between the images being morphed are subjected to interpolation at weighting factors correlated to the synthesis ratios, so that the interpolation produces after-synthesis corresponding points. Respective intensities at pixels located near each of the after-synthesis corresponding points on the images being morphed are blended by interpolation similar to the above, thus providing a synthesized image, i.e., morphed image. FIG. 6 shows one practical example of this morphing technique, where the face image of a figure is given as a first image being morphed and the face image of a dog is given as a second image being morphed. These two face images are synthesized based on the morphing technique described above.

From the first image being morphed to the second image being morphed, the synthesis ratios are changed gradually to produce a plurality of morphed images which are different in interpolating weighting factors from each other. Playing the plurality of morphed images frame by frame provides a unique transition animation which allows the first image being morphed (figure) to gradually change to the second image being morphed (dog). In a restricted sense, the technique for producing this kind of transition animation may be called as “morphing.”

In addition to the above conventional morphing technique which gives the synthesis process to two sets of images being morphed, a technique for synthesizing three or more sets of images is now being researched, which is referred as a polymorphing technique. This is exemplified by “IEEE Computer Graphics and Applications, January/February 1998, 60-73”.

The morphing technique has been applied to audio synthesis, as exemplified by Japanese Patent Laid-open Publication No. 2002-229579; Kawahara, H., Katayose, H., Cheveign'e, de A., and Patterson, R. D. “Fixed Point Analysis of Frequency to Instantaneous Frequency Mapping for Accurate Estimation of F0 and Periodicity”, Eurospeech '99, Vol. 6, pp. 2781-2784; and “Extending STRAIGHT-based Speech Morphing for Case-Based Design Assistance”, The 20th Annual Conference of the Japanese Society for Artificial Intelligence, 2006, 1D1-5.

The audio synthesis exemplified by the above reference uses a Fourier transform, which allows audio input waveforms to be two-dimensionally mapped in the form of power spectra. Similarly to the image synthesis, the morphing can thus be applied to this audio synthesis. For example, when the same person says “I love you,” the Fourier-transformed waveforms of the words change depending on person's emotion at the time the person say so. Hence, power spectrums of image waveforms in which various types of emotions, such as “delight”, “anger”, “sorrow”, and “pleasure”, are typically reflected are first prepared as audio data being morphed. Feature points, which are similar to the corresponding points for imaged being morphed, are then given on the spectrums, and subjected to the interpolation, which is similar to the foregoing, to produce a to synthesized power spectrum. This spectrum is then subjected to the inverse transform to the audio waveform, which is thus able to output a sound with an intermediate emotion among the typical emotions. In the example given by “http://www.wakayama-u.ac.jp/˜kawahara/Miraikandemo/straight Morph.swf”, the audio morphing is applied to three audio waveforms being morphed, which is a polymorphing technique for audio signals.

By the way, the image polymorphing shown by the foregoing reference “IEEE Computer Graphics and Applications, January/February 1998, 60-73” is a technique which extends a paradigm for the ordinary morphing applied to two images to that for morphing a desired number (M frames) of images. For morphing M-frames of images, the number of independent variables is M−1, because there is a restriction that normalized synthesis ratios for the respective images are summed up to 1. Hence, a morphed image can be expressed by the coordinates of the “M−1”-dimensional space. In this IEEE reference, each image is formulated by a single vertex of a single “M−1”-dimensional simplex and synthesis ratios for the respective images being morphed are expressed by a single point in the simplex. For example, when the images being morphed are three in so number, it is possible to express the synthesis ratios as two-dimensional coordinate points. In this case, the simplex is a triangle.

In the foregoing IEEE reference, the polymorphing, which strictly complies with a synthesis ratio expression on the simplex, is performed where decomposition is made for interpolation synthesis between two images. FIG. 10 shows a case where the synthesis is made among three images P₀, P₁ and P₂ corresponding to the vertexes of the triangular simplex. Wᵢⱼ shows a warp function from image Pᵢ (i=0, 1, 2) to image Pⱼ (j=0, 1, 2) and specifies points on image Pⱼ respectively corresponding to points on image Pᵢ.

To produce a final synthesized image Pₓ, Wᵢⱼ is applied to a center-of-gravity coordinate gⱼ of the image Pⱼ to linearly interpolate Wᵢⱼ to each image Pᵢ so as to have an intermediate warp function W̅ᵢ̅ (refer to FIG. 10). This intermediate warp function W̅ᵢ̅ allows two mutually adjacent images Pᵢ to be subjected to intermediate synthesis at weighting factors depending on the gravitational coordinate G* of a coordinate pₓ being morphed, thereby producing an in-between image Pi⁻. The synthesized image Pₓ is then obtained by linearly linking the respective points of the in-between image P̅ᵢ̅ at the weighting factors indicated by the center-of-gravity coordinate gⱼ.

In the practical example in FIG. 11, there are three vertex points A, B and C that provide coordinates pₐ, p_{b} and p_{c} being morphed and a single point X that provides a morphed coordinate pₓ. Draw lines extending from the three vertexes A, B ad C of this triangle ABC through the point X so as to intersect each edge so as to gain intersections D, E and F on the edges. The respective components gₐ, g_{b} and g_{c} at the center-of-gravity coordinate G* of the morphed coordinate pₓ are expressed by a formula (1):

$$\begin{matrix} {G}^{⋆} ≡ ( {g}_{a} , {g}_{b} , {g}_{c} ) \\ {g}_{a} = \frac{DX}{AD} {g}_{b} = \frac{EX}{BE} {g}_{c} = \frac{FX}{CF}\end{matrix} \qquad ( 1 )$$

so The respective coordinates at the respective points and the lengths of the respective segments can easily be calculated on known calculation methods. Three in-between images P̅ᵢ̅ (P_{d}, Pₑ and P_{f}) can thus be calculated on a formula (2):

$$\begin{matrix}{P}_{d} = \frac{CD}{BC} \cdot {P}_{c} + \frac{BD}{BC} \cdot {p}_{b} \\ \begin{matrix}{p}_{e} = \frac{AE}{CA} \cdot {P}_{a} + \frac{CE}{CA} \cdot {p}_{c} \\ {P}_{f} = \frac{BF}{AB} \cdot {P}_{b} + \frac{AF}{AB} \cdot {P}_{a}\end{matrix}\end{matrix} \qquad ( 2 )$$

As a result, on a formula (3);

Pₓ=gₐ·P_{d}+g_{b}·Pₐ+g_{c}·P_{f} (3),

the final synthesized image Pₓ is calculated as a linearly-linked image of the in-between images P_{d}, Pₑ and P_{f} which requires the weighting factors gₐ, g_{b}, and b_{c}.

By the way, it is probable that the same algorithm as that used in the above three-image polymorphing is applied to the three image-waveform morphing described in “http://www.wakayama-u.ac.jp/˜kawahara/Miraikandemo/straightMo rph.swf”.

In the conventional polymorphing process, synthesizing three or more sets to images becomes complex, as clear from FIG. 10. First of all, the interpolation and synthesis process needs to be performed 3 times between two sets of images, depending on the number of edges of the simplex, so that intermediately synthesized images are obtained. Further, it is needed to linearly link those intermediate synthesized images with regard to a gravity coordinate. That is, in total, 4 times of processes are required for synthesizing images.

When four sets of images are synthesized, this processing becomes complex further, because the simplex is a triangular pyramid having 6 edges. Practically, a line is set which connects each vertex and a triangular plane facing to the vertex via a desired morphing-destination coordinate. The intersection made between each triangular plane and each line can be regarded as an intermediate synthesis ratio point, with the result that the foregoing synthesis process for three sets of images is applied to four triangles. Four synthesized results are then subjected to the gravity linking process according to division ratios between the respective lines and the desired morphing-destination coordinate, so that a finally synthesized image is obtained. That is, the interpolation and synthesis processes is repeated 6 times and the gravity linking process is performed 5 times (=4+1 times), resulting in that, in total, the image synthesis process is required to be repeated 11 times. For synthesizing five sets of images, the simplex is a four-dimensional hyper-solid having not only 10 edges made by 5 triangular pyramids but also 5 planes. In this case, to gain a finally synthesized image, it is required that the interpolation and synthesis process is performed 10 times and the gravity linking process is performed 11 times (=5+5+1 times); in total, the image synthesis process should be repeated 21 times.

In this way, as the number of sets of images being polymorphed increases, the number of image synthesis processes, that is, the calculation load increases sharply.

### SUMMARY OF THE INVENTION

The present invention has been made in consideration of the foregoing difficulty, and an object of the present invention is to provide a data polymorphing method and apparatus that are able to polymorph three or more sets of data with a smaller number of image processing operations, i.e., less calculation load.

In order to achieve the above object, the present invention provides, as one aspect thereof, a method of polymorphing 2^{M}-sets of model data strings being morphed (M is a positive integer and M≧2), comprising steps of: acquiring the model data strings by defining at least 2^{M}-piece coordinates being morphed in a M-dimensional model-data mapping space and making the defined model data strings correspond to the coordinates being morphed, respectively; setting a unit cell in the model-data mapping space, the unit cell consisting of a hyper rectangular parallelepiped having 2^{M}-piece vertexes each located at the coordinates being morphed; selecting a desired coordinate, as a morphing-destination coordinates within the unit cell; polymorphing the 2^{M} sets of model data strings corresponding, set by set, to the coordinates being morphed using weighting factors depending on distances from the respective coordinates being morphed to the morphing-destination coordinate in the unit cell, so that a string of synthesized data corresponding to the morphing-destination coordinate is produced; and outputting the string of synthesized data using an outputting device.

As another aspect, the present invention provides an apparatus for polymorphing 2^{M}-sets of model data strings being morphed (M is a positive integer and M≧2), comprising steps of: acquiring means for acquiring the model data strings by defining at least 2^{M}-piece coordinates being morphed in a N-dimensional model-data mapping space and making the defined model data strings correspond to the coordinates being morphed, respectively; setting means for setting a unit cell in the model-data mapping space, the unit cell consisting of a hyper rectangular parallelepiped having 2^{M}-piece vertexes each located at the coordinates being morphed; selecting means for selecting a desired coordinate, as a morphing-destination coordinate, within the unit cell; polymorphing means for polymorphing the 2^{M} sets of model data strings corresponding, set by set, to the coordinates being morphed using weighting factors depending on distances from the respective coordinates being morphed to the morphing-destination coordinate in the unit cell, so that a string of synthesized data corresponding to the morphing-destination coordinate is produced; and outputting means for outputting the string of synthesized data using an outputting device.

In the present invention, model data strings, which are targets for morphing, are mapped in the model-data mapping space so as to correspond to coordinates being morphed. The number of vertexes of a unit cell to which the coordinates being morphed are given is 2^{M} (M≧2). That is, the unit cell having vertexes larger in number than a conventional M-dimensional simplex (whose vertexes are M+1 in number) is adopted. Practically, the unit cell is selected as a hyper rectangular parallelepiped whose vertexes are 2^{M} in number. Provided that the model-data mapping space is expressed by an orthogonal to coordinate system, the hyper rectangular parallelepiped is a rectangular parallelepiped (including a cube) when the dimensional number M is 3 and a rectangular (including a square) when the dimensional number M is 2.

In the case where all the vortexes of the unit cell, that is, all the coordinates being morphed are set at random, polymorphing calculation needs to take “M×(the number of vertexes)”-piece coordinate values into consideration, because there are M-piece coordinate components per each of the coordinates being morphed. In contrast, in the present invention, the foregoing hyper rectangular parallelepiped is employed and the lengths of the respective edges (M-piece edges) of this parallelepiped are given. In consequence, the value of one coordinate being morphed, which composes one of the vertexes of the parallelepiped, can be used to decide the values of the other coordinates being morphed. As a result, compared to the use of the simplex, the interpolation for polymorphing can be simplified greatly.

Based on a geometric relationship between the coordinates being morphed (i.e., the originating coordinates for morphing) which are present as the vertexes of the hyper rectangular parallelepiped and a morphing-destination coordinate (i.e., a coordinate to which the morphing is performed), model data strings corresponding to the respective coordinates being morphed are linearly interpolated and synthesized to produce a synthesized image. In this process, the following polymorphing algorithm gives a calculator a great simplicity.

That is, the hyper rectangular parallelepiped is first divided by M-piece planes passing the morphing-destination coordinate and being parallel to the respective planes of the hyper rectangular parallelepiped. This produces 2^{M}-piece partial rectangular parallelepipeds each having the morphing-destination coordinate and each exclusively having one coordinate being morphed which is present at one of the vertexes of the hyper rectangular parallelepiped. When the model-data mapping space is an orthogonal coordinate system, each partial rectangular parallelepiped becomes a rectangular parallelepiped (including a cube) for the dimensionality M=3. In this case, the hyper rectangular parallelepiped is divided into 8 partial rectangular parallelepipeds. Moreover, for the dimensionality M=2 in this coordinate system, each is partial rectangular parallelepiped becomes a rectangle (including a square), and this rectangle is allowed to be divided into 4 partial rectangles. When being generalized into the M-th dimension, the number of partial rectangular parallelepipeds divided from a hyper rectangular parallelepiped is 2^{M}.

Each partial hyper rectangular parallelepiped is then subjected to polymorphing calculation using weighting factors. The weighting factors are set such that a relative volume of each partial rectangular parallelepiped to the hyper rectangular parallelepiped is given as a weighting factor assigned to a coordinate being morphed of the hyper rectangular parallelepiped located diagonally oppositely to the coordinate being morphed of the partial rectangular parallelepiped. Thus the weighting calculation is converted into calculating the volumes of the respective partial rectangular parallelepipeds and the volume ratios. Accordingly, by way of example, liner interpolation between two points can be used, so that model image data strings can be synthesized easily into a final image by only repeating the synthesis calculation using the two-point linear interpolation.

The algorithm for the polymorphing calculation that uses the relative volume ratios (weighting factors) of the respective partial parallelepipeds will not be restricted to particular ones. Provided being mathematically identical to the foregoing, any calculation techniques can be adopted. For example, an alternative is that the morphing process for two sets of model data strings is repeated sequentially plural times depending on the dimensionality of the mapping space.

The data being processed by the polymorphing method and apparatus according to the present invention will not be limited to particular ones as well. Like the known morphing techniques, it is preferred that the present invention is typically applied to image data and audio data.

### BRIEF DESCRIPTION OF THE DRAWINGS

In the accompanying drawings:

FIG. 1 is a block diagram exemplifying the electric construction of a data polymorphing apparatus according to the present invention;

FIG. 2 is an illustration showing a model-data mapping space and image data composing a model data string;

FIGS. 3A-3C illustrate how to polymorph images according to the present invention;

FIG. 4 is a flowchart exemplifying an algorithm of the polymorphing method according to the present invention;

FIG. 5 shows an example of image data processed in an embodiment of the present invention;

FIG. 6 illustrates an example of how to morph two images;

FIG. 7 pictorially shows an example of polymorphing images;

FIG. 8 pictorially shows an example of polymorphing audios;

FIG. 9 explains the envelope of an audio power spectrum and a concept of how to separate spectral fine structures; and

FIGS. 10 and 11 are illustrations explaining the concept of a conventional polymorphing technique.

### DETAILED DESCRIPTION OF THE PREFERRED EMBODIMENTS

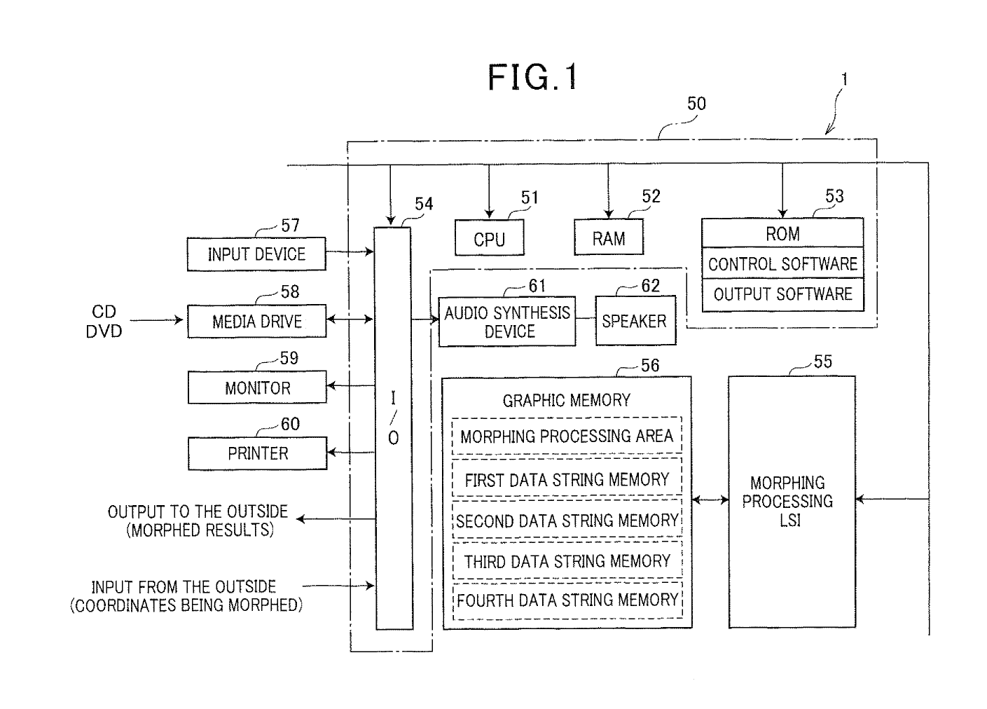

Referring to FIGS. 1-9, an embodiment of a data polymorphing apparatus 1 and method according to the present invention will now be described.

As shown in FIG. 1, the data polymorphing apparatus 1 is provided with a known microcomputer 50 serving as an essential control member. The microcomputer 50 is provided with a CPU (central processing unit) 51, a RAM (random access memory) 52, a ROM (read-only memory) 53, and an input/output interface 54, all of which are mutually connected by a bus. In the ROM 53, programs for controlling and managing the entire polymorphing process and for outputting polymorphed results (image and audio representation) and other necessary information are stored in the form of software source codes. The RAM 51 is used as a work area for the CPU 51. While using this RAM 51, the CPU 51 executes the programs stored in the ROM 53 so that the polymorphing process and the output process will now be performed.

Various devices are communicably connected are communicably connected to the input/output interface 54. Such devices include an input device 57 including a keyboard and a voice recognition input device, a media drive 58 to read contents from external media devices such as a CD or a DVD, a monitor 59, a printer 60, an audio synthesis device 61, a speaker 62 for outputting voice messages. The audio synthesis device 61 synthesizes audio wave signals given as audio data.

A morphing processing LSI 55 and a graphic memory 56 are also connected to the bus of the microcomputer 50. The morphing process LSI 55 complies with commands issued from the CPU 51 and, in response to such commands, executes a polymorphing calculation and a data-string synthesis process using a string of model data to be polymorphed. The string of model data is given as image data or audio data (or given as profiles of power spectra or cepstra). In the graphic memory 56, there are formed a morphing process area for the data-string synthesis process and a memory area for storing the string of model data.

The present embodiment exemplifies a process of synthesizing four model data strings in a two-dimensional model-data mapping space. The number of data strings is 2²=4, while the number of memory areas for storing the model data strings is four. The dimension of the model-data mapping space may be three or more. For example, in the three-dimensional model-data mapping space, the number of model data strings is 2³=8, so that there are formed eight memory areas for storage.

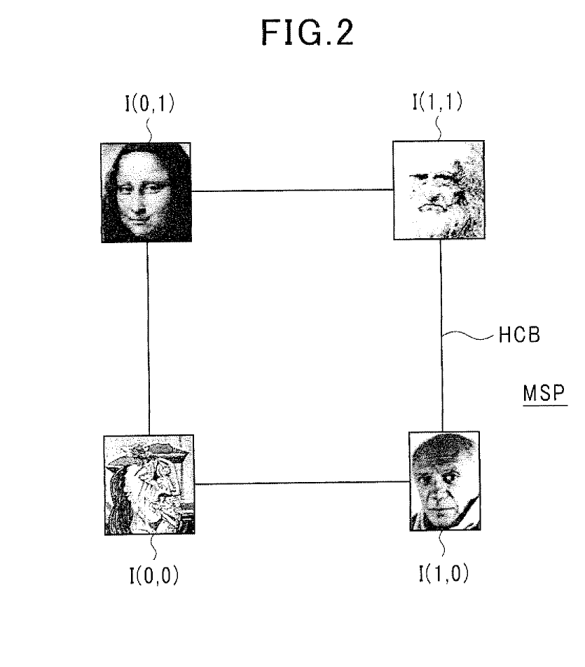

In the image morphing, the model data strings are given as image data being morphed (i.e., originating image data for morphing). In the present embodiment, as shown in FIG. 2, a rectangular unit cell HCB is defined in a two-dimensional model-data mapping space MSP. The four vertexes of the unit cell HCB are set to be coordinates being morphed (i.e., originating coordinates for morphing) and four image data being morphed, I(0,0), I(1,0), I(1,0), I(0,1), are prepared which are made to be correspondent, one by one, to the respective coordinates being morphed. These image data being morphed are stored in an external medium, for example, and read by the media drive 58 from the external medium. The read-out image data are then transferred via the I/O interface 54 and the morphing processing LSI 55 to the predetermined memory areas of the graphic memory 56. In place of this data acquisition technique, it is possible to download the image data being morphed from an external delivery site via a communication network to be connected to the present data polymorphing apparatus 1.

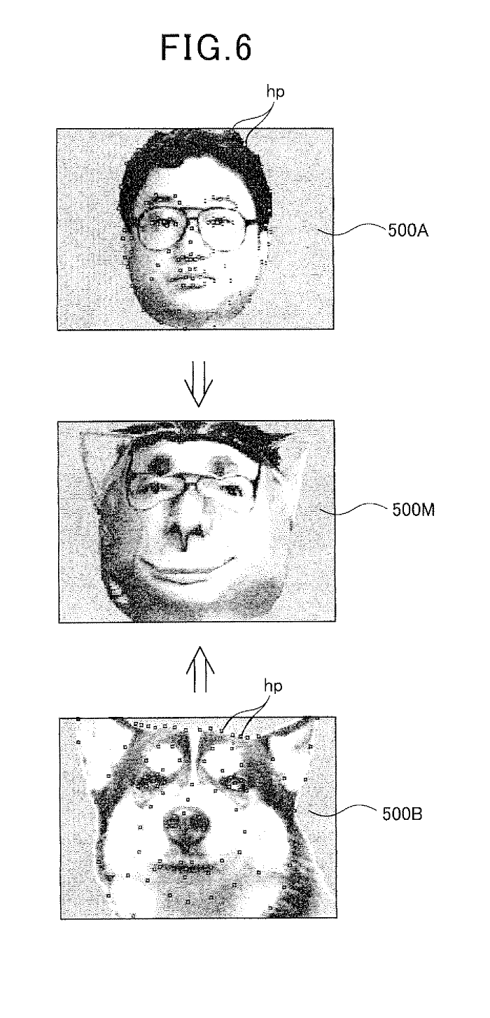

The contents of the image data being morphed, that is, image objects to be polymorphed are not restricted to a particular one, As shown in FIG. 6, for example, the image data being morphed may include a face image 500A of a figure and a face image 500B of an animal. Such a polymorphed image improves flexibility in producing images.

On the image data being morphed 500A and 500B, a plurality of corresponding points hp are mapped, which indicate the characterizing portions of the faces. By specifying a morphing synthesis ratio, the coordinates of the corresponding points hp are interpolated in the respective images 500A and 500B, so that the interpolated points provide corresponding points in a synthesized face image 500M. During the polymorphing process, the synthesis ratio is also used to interpolate the values of plural pixels located, with a given positional relationship, near each corresponding point hp in the synthesized face image 500M. The corresponding points hp are mapped, in part, on the contours of the faces and the paths along the contours of members such as eyes, eyebrows, mouths, and noses. Thus the pixels along the paths can be designates as corresponding pixel groups for interpolating the outputted pixel values of the synthesized face image 500M.

In the present embodiment, polymorphing the face images of figures will now be exemplified. Various such polymorphing ways are conceivable For example, polymorphing face images of parents' earlier generations may provide, as a morphed result, the face image of a child to be expected. Another example is to polymorph different face images in which different facial expressions of the same person are reflected.

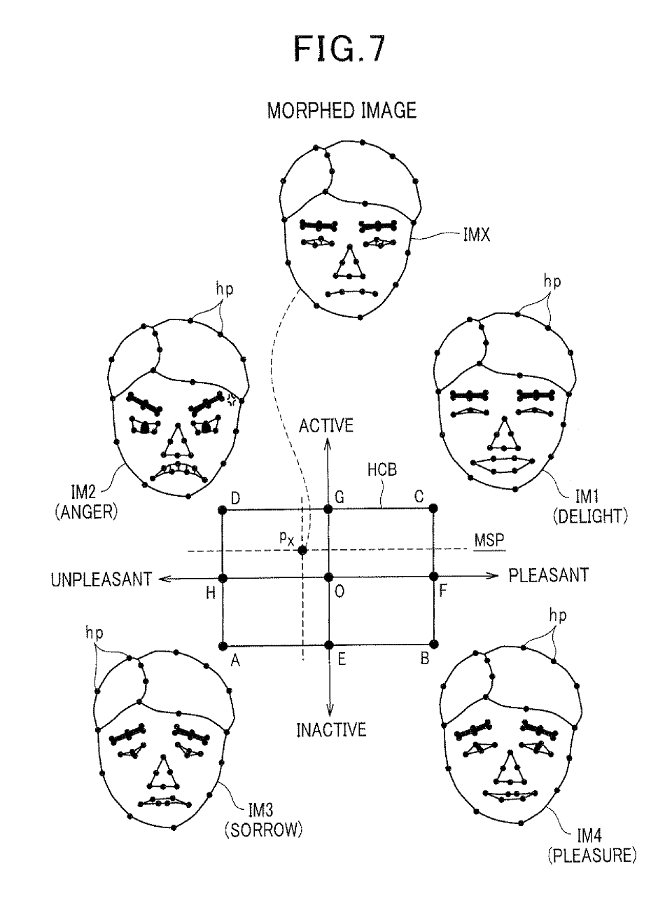

Hereinafter, one such an example of polymorphing different face images will now be explained, which face images provide different facial expressions of the same person. As shown in FIG. 7, the model-data mapping space MSP is set as a two-dimensional emotional plane (a plane to express emotions, which is depicted in the x-y plane, for example) which allows its ordinate axis to express a mental activation level (wakefulness degree) and its transverse axis to express a pleasantness degree. The unit cell HCB is thus rectangular. The four vertexes of this unit cell HCB provide four coordinates C, D, A and B being morphed, which correspond to four face image data IM1, IM2, IM3 and IM4. These face image data IM1 to IM4 provide the four types of facial expressions of the same person which are pointed out by the four coordinates C, D, A and B being morphed in the two-dimensional emotional plane.

The two-dimensional emotional plane is based on, what is called, a concept of Russell-Mehrabian's emotional plane and has four quadrants that correspond to mental conditions of delight, anger, sorrow and pleasure, respectively. That is, such mental conditions are an activated state (pleasure: a higher mental activation level/pleasantness), anger/excited state (anger; a higher mental activation level/unpleasantness), and disappointment/boredom (a lower mental activation level/unpleasantness). The more the distance from the origin O in the plane, the higher the mental condition of each of delight, anger, sorrow and pleasure inherent to the respective quadrants. The origin O shows a neutral mental condition with less emotional characteristics.

As shown in FIG. 7, for example, when the unit cell HCB is defined to extend to the four quadrants, the coordinates being morphed (i.e., coordinates from which the morphing is performed) C, D, A and B (that is, the coordinates at the four vertexes) have face image date IM1, IM2, IM3 and IM4 which express typical four facial expressions of delight, anger, sorrow and pleasure of the same person. In this unit cell HCB (i.e., the two-dimensional emotional plane MSP), a morphing-destination coordinate (i.e., a coordinate to which the morphing is performed) pₓ showing a desired emotional condition is set based on operator's information coming from the input d3vice 57. Depending on a technique later described, the face image data IM1, IM2, IM3 and IM4 are polymorphed at weighting factors decided by the morphing-destination coordinate pₓ, so that a face image in which the desired emotional condition is reflected can be obtained by synthesis based on the polymorphing.

The face image data IM1, IM2, 1M3 and 1M4 are face images of the same person, so that the contour of the entire face and the contours of components such as the eyes, eyebrows, mouth, nose, and head hair in the respective images are very close to each other with the exception of changes depending on his or her emotions. It is thus easy to set, in each image, corresponding points hp mutually corresponding among the images. Using the four face image data, it is thus possible to naturally express face images in which any emotional conditions of the person are reflected.

Moreover, the rectangular unit cell HCB is used, with the result that the face of the person can be expressed more freely and naturally so as to make reference to the four emotions of delight, anger, sorrow and pleasure. In this respect, because the conventional polymorphing technique uses a triangular unit cell, it is difficult to cover the four emotions. A modification is that, instead of using the two-dimensional face data as shown in FIG. 7, three-dimensional face data can also be used. In addition, in place of using the data of photographed image of human faces, the data of painted or illustrated face images may also be adopted.

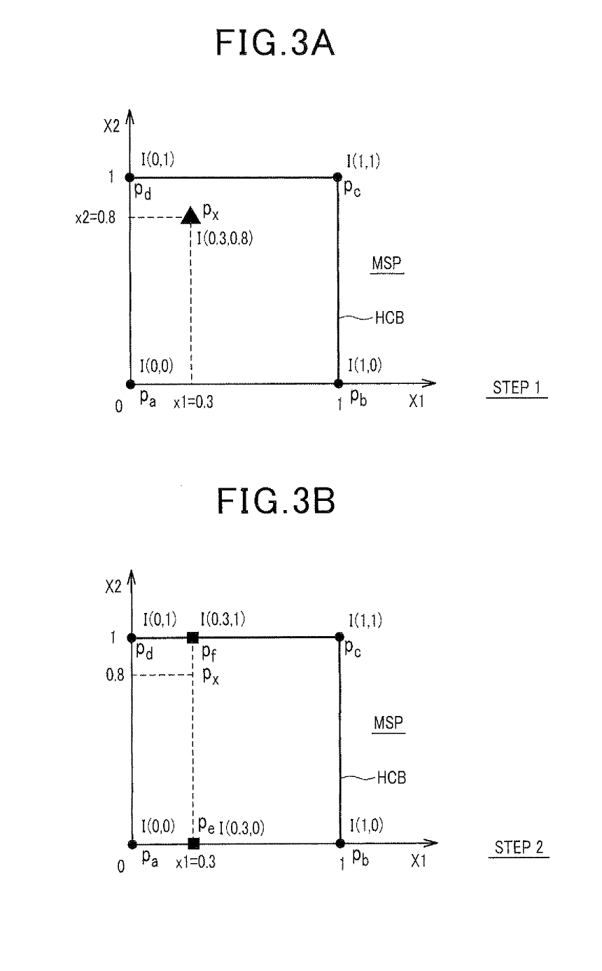

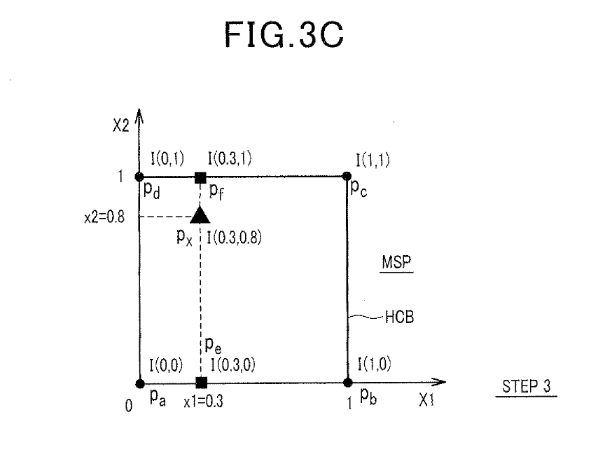

An algorithm for the polymorphing technique according to the present invention will now be described, in which the rectangular unit cell is a square unit cell whose respective edges have a length of 1 and an morphing-destination coordinate pₓ (i.e., a two-dimensional vector) is expressed by (x1, x2) (0≦x1≦1,0≦x2≦1). As shown in FIG. 3A, the square unit cell HCB has two axes, which may be expressed as X1 and X2. The morphing-destination coordinate pₓ points out an inner point in the unit cell HSB, which inner point is X1=x1 and X2=x2. FIG. 3A exemplifies x1=0.3 and x2=0.8. A finally targeted image is to obtain a synthesized image I (x1, x2) pointed out by the morphing-destination coordinate pₓ using the four images I (b1, b2). Since the dimension M of the model-data mapping space MSP is 2, the practical calculation is completed by two steps. Of course, as described, when the model-data mapping space MSP has M dimensions, the morphing needs M steps of calculation. Each step for the morphing will now be detailed.

In the first step, as shown in FIG. 3B, the orthogonally projected points pₑ and pf of the morphing-destination coordinate pₓ to each of parallel mutually-opposed edges of the square unit cell HCB (edges “pₐ-p_{b}” and “p_{d}-p_{c}” in FIG. 3B) are obtained as equinoctial points. Then the known first-order morphing process is performed, where the face image data (i.e., model data strings) corresponding to the morphing-destination coordinates located at both ends of each of mutually-opposed edges (i.e., pₐ: I(0, 0) and p_{b}: I(1, 0); and p_{d}: I(0, 1) and p_{c}: I(1, 1)) are then subjected to interpolation using weighting factors defined by the relationship of the leverage. This provides a single pair of strings of in-between image data I (0.3, 0) and I(0.3, 1).

The second step is then carried out. In the second step, as shown in FIG. 3C, the morphing-destination coordinate pₓ on the line connecting the forgoing orthogonally projected points pₑ and pf is treated as a new equinoctial point. For this equinoctial point, a single pair of strings of in-between data pₑ: I(0.3, 0) and pf: I(0.3, 1) are subjected to the second-order morphing process using weighting factors defined by the relationship of the leverage. This provides finally synthesized image data (a string of synthesized data).

The synthesized image data is then displayed by the monitor 59, printed by the printer 60, or outputted to an external system connected to this apparatus via the communication system.

By the way, the present apparatus may be designed such that the information showing the morphing-destination coordinate pₓ is so given via a wireless and/or wired network system from an external device located outside the present apparatus.

Moreover, it is preferred that the above steps shown in FIGS. 3A to 3C are carried out automatically in response to an initial operator's command or interactively with operator's commands given via the input device 57. It is also preferred that how the steps related to FIGS. 3A to 3C are processed are visualized in real time by the monitor 59 during the automatic or interactive calculation.

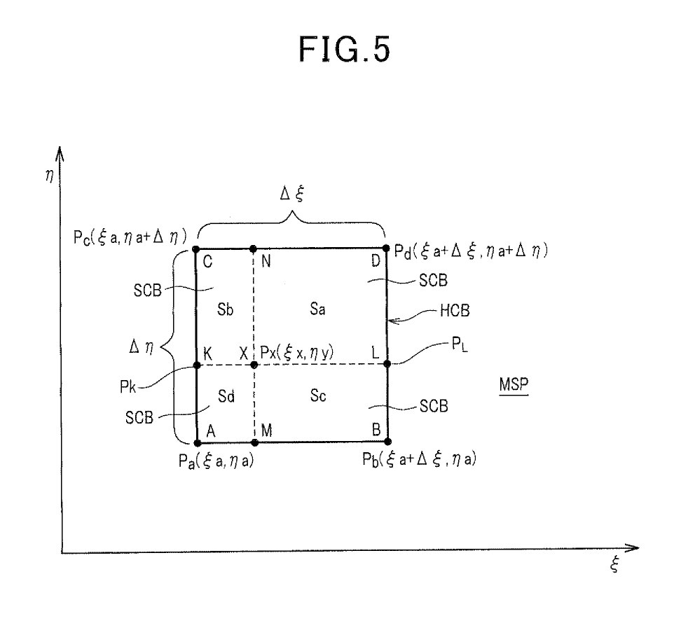

FIG. 5 conceptually explains an algorithm for polymorphing in the case where there are M dimensions (M is an integer satisfying M≧2). The coordinates being morphed pₐ, p_{b}, p_{c} and p_{d} are at the vertexes A, B, C and D of the rectangular unit cell HCB (serving as a hyper rectangular parallelepiped). This unit cell HCB is divided into cell pieces by being cut by two linear lines (two planes) which are respectively parallel to each of the edges CA and DB; and CD and AB and which passing the morphing-destination coordinate pₓ. Hence, the unit cell HCB is sectioned into four (2^{M} (i.e., power of 2) pieces) partial rectangles SCB, which consist of rectangles CKXN (area S_{b}), NXLD (area Sₐ), KAMX (area S_{d}), and KMBL (area S_{d}). Each of these partial rectangles has, as a common coordinate point, the morphing-destination coordinate X (given as pₓ) and exclusively has each of the coordinates being morphed given by the vertexes of the rectangular unit cell HCB.

Thus, the following formulae (11) to (12) are realized.

$$\begin{matrix}{P}_{L} = \frac{DL}{DB} \cdot {P}_{b} + \frac{LB}{DB} \cdot {P}_{d} & ( 11 ) \\ {P}_{k} = \frac{DL}{DB} \cdot {P}_{a} + \frac{LB}{DB} \cdot {P}_{c} & ( 12 )\end{matrix}$$

A relative area (a relative volume) of each partial rectangle SCB (serving as a partial parallelepiped) SCB to the rectangular unit cell (serving as a hyper rectangular parallelepiped) HCB is then obtained. Each relative area (each relative volume) is used as a weighting factor to each of coordinates being morphed p_{d}, p_{c}, pₐ, and p_{b} which are diagonally opposite to the coordinates being morphed pₐ, p_{b}, p_{d} and p_{c}, respectively, which undergo the calculation of its relative area (relative volume). The resultant weighting factors are used in the polymorphing process. Namely, when assuming that the rectangular unit cell HCB has an area S₀, a synthesized image Pₓ can be provided by calculation of:

$$\begin{matrix}\begin{matrix}{P}_{x} = \frac{DN}{CD} \cdot {P}_{k} + \frac{NC}{CD} \cdot {P}_{L} \\ = \frac{DN}{CD} ( \frac{DL}{DB} \cdot {P}_{a} + \frac{LB}{DB} \cdot {P}_{c} ) + \frac{NC}{CD} ( \frac{DL}{DB} \cdot {P}_{b} + \frac{LB}{DB} \cdot {P}_{d} ) \\ = \frac{1}{{s}_{o}} ( {S}_{a} \cdot {P}_{a} + {S}_{b} \cdot {P}_{b} \cdot {S}_{c} \cdot {P}_{c} + {S}_{d} \cdot {P}_{d} )\end{matrix} & ( 13 )\end{matrix}$$

The foregoing polymorphing process may be modified as follows. In the case shown in FIGS. 3A to 3C, the calculation is started from the calculation for the edges “pₐ-p_{b}” and “p_{d}-p_{c}”, but this is just one example. The calculation may be started from the edges “pₐ-p_{d}” and “p_{b}-p_{c}” which will also leads to an equivalent formula to the foregoing formula (13). Practically, orthogonally projected points of the morphing-destination coordinate pₓ to the segments DB and CA are set to be L and K. In this condition, an in-between image data P_{L} on the segment DB is interpolated by the formula (11), while an in-between image data P_{K} on the segment CA is interpolated by the formula (12). Since there is the morphing-destination coordinate point X on the segment KL, the resultant first-order in-between images P_{L} and P_{K} then undergo the interpolation, which is identical to the above, using the point X as an equinoctial point. This also provides a synthesized image Pₓ which is accordance with the formula (13).

When the polymorphing-destination coordinate pₓ is given as a ξ-η coordinate system, that is, there are provided coordinates pₓ(ξₓ, η_{y}), pₐ(ξₐ, ηₐ), p_{b}(ξₐ+Δξ, ηₐ), p_{c}(ξₐ, ηₐ+Δη), and p_{d}(ξₐ+Δξ, ηₐ+Δη), formulae (14)-(16) are realized as;

when assuming that

Sₒ≡CD·DB

Sₐ≡DN·DL

S_{b}≡NC·DL

S_{c}≡DN·LB

S_{d}≡NC·LB (14) and

ξ′ₓ≡ξₓ−ξₐ

η′_{y}≡η_{y}−ηₐ (15),

there can be provided such that

S₀=Δξ·Δη

Sₐ=(Δξ−Δξ′ₓ)(Δη−η′_{y}) S_{b}=ξ′ₓ·(Δη−η′_{y})

S_{c}=η′_{y}·(Δξ−ξ′ₛ) S_{d}=ξ′ₓ·η′_{y} (16).

Thus the synthesized image Pₓ can also be expressed by a formula (17):

$${P}_{x} = \frac{1}{Δ ξ \cdot Δ η} \{ \begin{matrix}( Δξ - {ξ}_{x}^{′} ) ( Δη - {η}_{y}^{′} ) \cdot {P}_{a} + \\ {ξ}_{x}^{′} \cdot ( Δη - {η}_{y}^{′} ) \cdot {P}_{b} + \\ {η}_{y}^{′} \cdot ( Δξ - {ξ}_{x}^{′} ) \cdot {P}_{c} + {ξ}_{x}^{′} \cdot {η}_{y}^{′} \cdot {P}_{d}\end{matrix} \} . \qquad ( 17 )$$

As shown in FIG. 7, in the case where the rectangular cell HCB is spread over the four quadrants, the intersections G, H, E and F made by the origin O and the respective ordinate and transverse axes can be added as new coordinates being morphed, so that corresponding five face image data (i.e., model data strings) can be prepared. In this case, four partial rectangular unit cells OFCG, OGDH, OHAE and OEBF are produced adjacently to each other in each quadrant to be spitted by the origin O. When a morphing-destination coordinate pₓ is specified, this coordinate pₓ undergoes determination of whether or not this point pₓ belongs to which partial rectangular unit cell OFCG (OGDH, OHAE and OEBF). After this determination, the face image data (i.e., model data strings) relevant to each partial rectangular unit cell are used for polymorphing which is carried out in the similar manner to the foregoing.

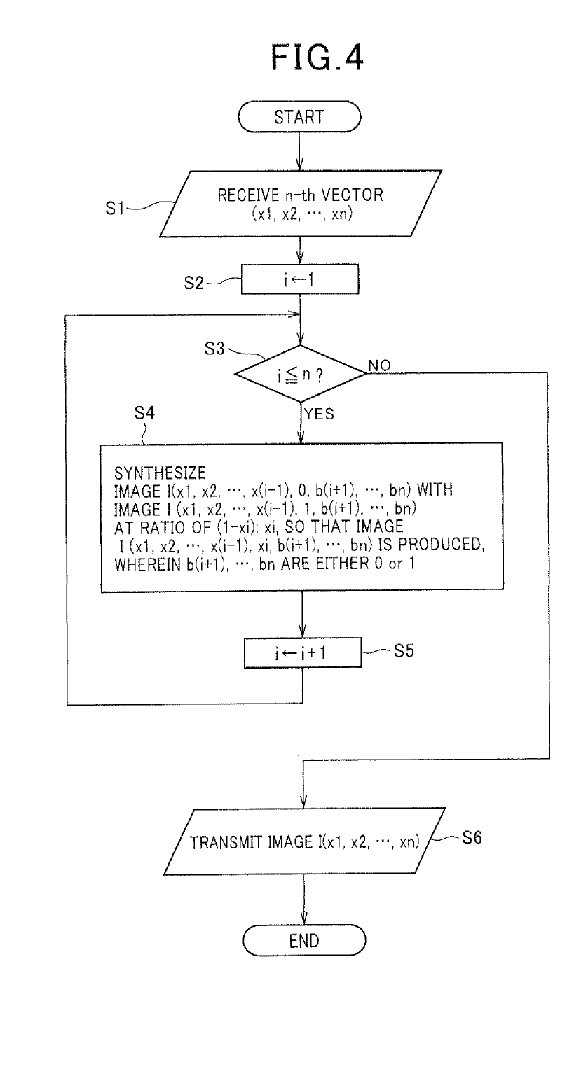

In the present invention, the dimensionality M of the model-data mapping space MSP may be 2 or more (M: positive integer). If the model-data mapping space is three-dimensional, the unit cell is given as a rectangular parallelepiped. In this case, the following three-step morphing process is performed. Any one of the three paired mutually-parallel planes (rectangular planes) is selected first, and orthogonally projected points to each of the paired mutually-parallel planes are calculated. As to each orthogonally projected point, the two-step morphing process, which is similar to the two-dimensional case described above, is performed on each rectangle composing each of the paired mutually-parallel planes, thus providing strings of the first-order in-between data, A segment connecting both the orthogonally projected points on the respective mutually-parallel planes is produced, on which the morphing-destination coordinate pₓ is orthogonally projected to produce a new equinoctial point. Using this new equinoctial point as a point provide weighting factors obtained from relationship of the leverage, the paired strings of the first-order in-between data are subjected to the three-dimensional morphing to finally provide a synthesized image string. FIG. 4 is a flowchart conceptually showing a generalized algorithm for the dimensionality M=n.

Specifically, the polymorphing algorithm shown in FIG. 7 is totally equivalent, in a mathematical sense, to obtaining a synthesized image Pₓ by sequentially performing the following interpolation and synthesis cal caution. Namely, between two coordinates being morphed which are located in each coordinate-axis direction of a hyper rectangular parallelepiped, an orthogonally projected point of a morphing-destination coordinate pₓ to the segment produced by those coordinates being morphed is set as an equinoctial point, and the first-order in-between image is synthesized based on the principle of the leverage. Then, with regard to a segment made between the corresponding orthogonally projected points, orthogonally projected points of the morphing-destination coordinate pₓ to the obtained first-order in-between images, which are obtained for two mutually opposed edges of each plane of the hyper rectangular parallelepiped HCB, is calculated as a new equinoctial point. Using this calculated equinoctial point, the first-order in-between images are synthesized based on the principle of leverage, whereby a second-order in-between image is produced (steps S1-S4). The steps at steps S3-S5 are repeated until the equinoctial point reaches the morphing-destination coordinate X. Then a finally synthesized image I at the morphing-destination coordinate pₓ is transmitted (outputted) to output means, which are for example the monitor 59, printed by the printer 60 (step S6).

By the way, the polymorphing technique according to the present invention can also be applied to synthesis of audio data (e.g., speech), not limited to the synthesis of image data, This is called an audio morphing technique; with which audio data is proceed as model data strings described above. In the audio morphing, model data strings are composed of audio waveform data (or their power spectral profiles or their cepstral profiles). The waveform data and those profiles can be depicted in the two-dimensional plane, so that, theoretically, these data and profiles can be regarded as images. It is therefore possible to polymorph the audio data in the same manner as the image morphing.

On the other hand, in this audio morphing, the forgoing known techniques of

Japanese Patent Laid-open Publication No. 2002-229579;

Kawahara, H., Katayose, H., Cheveign'e, de A., and Patterson, R. D.: “Fixed Point Analysis of Frequency to Instantaneous Frequency Mapping for Accurate Estimation of F0 and Periodicity,” Eurospeech'99, Vol. 6, pp. 2781-2784; and

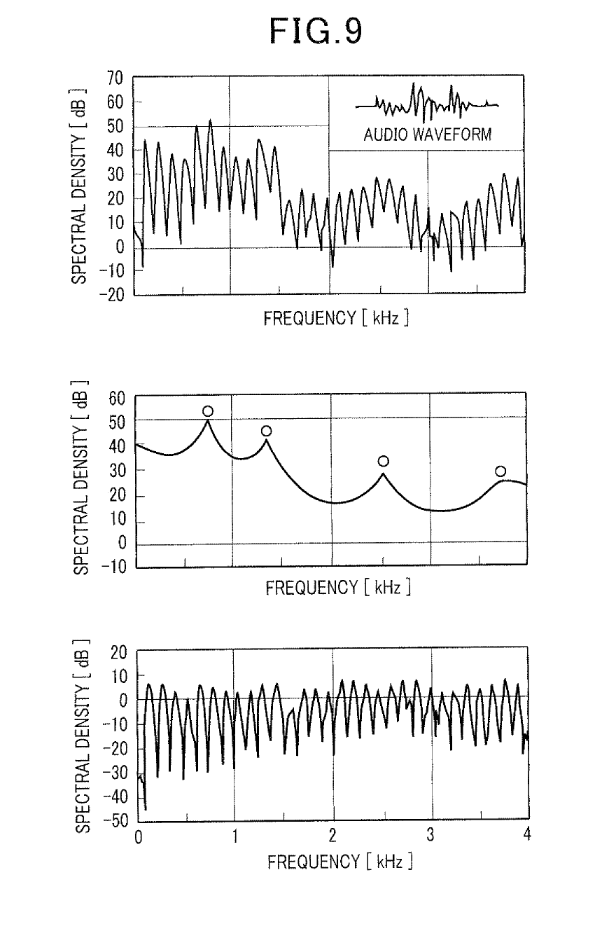

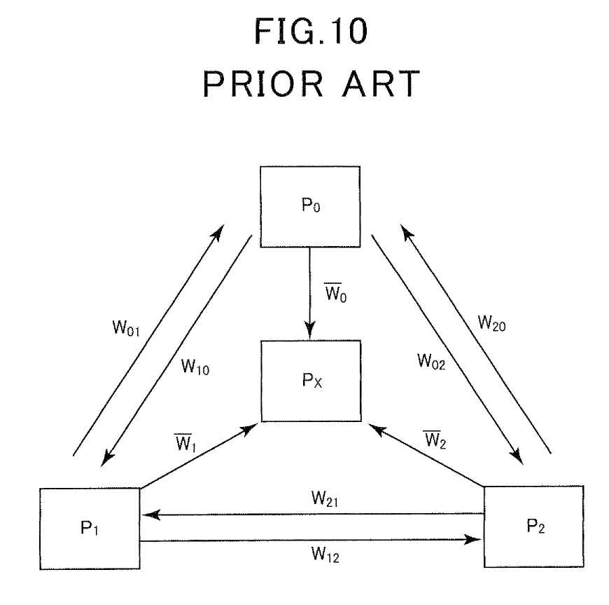

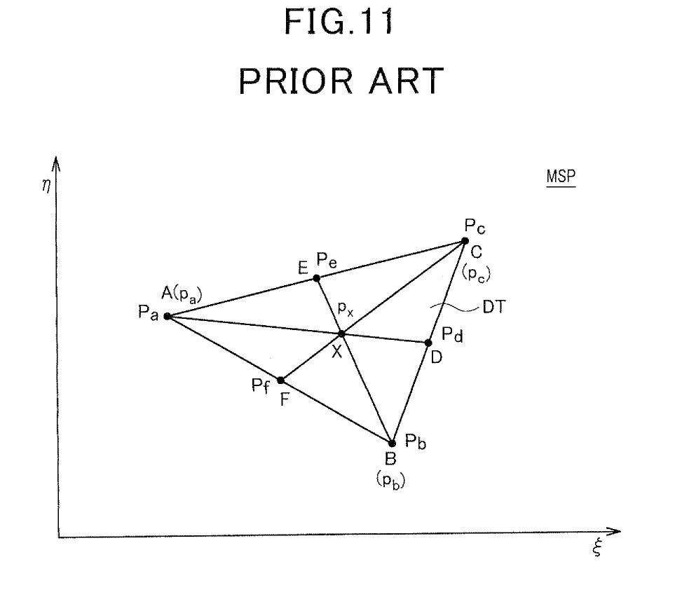

“Extending STRAIGHT-based Speech Morphing for Case-Based Design Assistance”, The 20th Annual Conference of the Japanese Society for Artificial Intelligence, 2006, 1D1-5 can be introduced, providing an easier and higher-probability audio morphing. For example, from a power spectrum of image waveform being morphed (refer to the uppermost column in FIG. 9), a known cepstrum analysis provides a spectral envelope (refer to the middle column in FIG. 9) and a spectral fine structure (refer to the lowermost column in FIG. 9) in a mutually separated manner. The spectral is envelope provides information in which the resonance characteristics of a vocal tract are mainly reflected, while the spectral fine structure provides information in which the sound-source characteristics of the vocal band are mainly reflected. Hence, the spectral envelope and the spectral fine structure of the audio waveform being morphed can undergo the polymorphing process individually.

In polymorphing the spectral envelope, the interpolation may be applied to only feature points such as peak points of the spectrum (refer to circles in FIG. 9). Moreover, as a technique to have a higher probability, the reciprocal function of an integral spectrum may be used as being known. The spectrum fine structure can be regarded as an element to control the pitches of the fundamental wave of an audio source emanated form the vocal band, so that the spectrum fine structure has lots of peaks corresponding to harmonics composing the fundamental wave. It is general in the audio morphing that these peak so points of the spectrum fine structure are interpolated in the frequency domain to expand or contact the pitches of the peaks.

Though the “STRAIGHT” technique disclosed by the above-referenced paper has been known as a processing engine for morphing two audio data sets (that is, speeches), this “STRAIGHT” technique may also be used in the present invention. The “STRAIGHT” technique is based on the architecture of a channel vocoder in order to separate and extract, from sound, filtering information (spectral envelope) and audio source information, In using the “STRAIGHT” technique, as shown by Speech Communication, Vol. 27, No. 3-4, pp. 187-207 (1999), adaptive smoothing can be applied, which is based on complementary time windows to be applied to the fundamental frequency of an audio source and a spline function theory in the frequency domain. By this application of the adaptive smoothing, amplitudes at harmonic positions are secured and, at the same time, interference with the spectral envelope being caused due to the periodicity of sound from the audio source is well removed.

When the “STRAIGHT” technique is used, the audio source information consists of information of a fundamental frequency and a non-periodical index indicative of the ratio between periodic components and non-periodic components in each frequency band. To extract the fundamental frequency, an algorithm is used which utilizes fixed points in projection from the central frequencies of filters to instantaneous frequencies for output thereof. The non-periodic index is calculated by combining, with comb filters, expanding/contraction of the time axis so that an apparent fundamental frequency becomes a constant, and by adopting correction based on simulated results (for example, refer to Eurospeech'99, Vol. 6, pp. 2781-2784 (1999)). The spectral envelope is converted to the impulse response of a minimum phase, and convolved with mixed audio sources (pulses and colored noise) which have undergone group delay. This overlap and add provide a synthesized audio waveform. In this way, the audio data are synthesized using the audio source information and the spectral envelope.

In the morphing using the “STRAIGHT” technique, the spectral envelope is displayed in time/frequency expressions and reference points for making reference to characteristic positions are set on the display. In the time domain direction, the four-to-five reference points are set per a single syllable consigning of consonants and vowels, whilst in the frequency domain direction, it is sufficient to set the three-to-five reference points until 5000 Hz. In the first step of the morphing process, a time/frequency plane for one of spectral envelopes to be processed is deformed so that the reference points are superposed on one the other. In the time/frequency planes which are made to be correspondent to each other, parameters are interpolated depending on a morphing rate at each reference point, whereby the morphed values of the parameters are calculated. Finally, depending on the morphing rates, the time-frequency planes are deformed. Supplying is the parameters to the synthesizing part which operates on the “STRAIGHT” technique, the morphed audio data are synthesized.

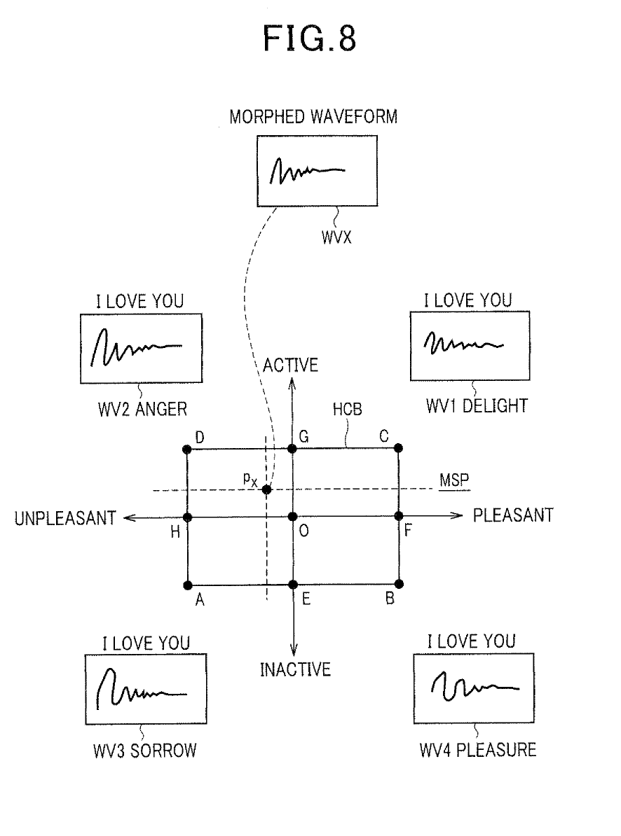

FIG. 8 shows an example of polymorphing audio data expressing the same sound (for example, “I love you.”) uttered by the same person. The model-data mapping space MSP is defined as a two-dimensional emotional plane which is similar to that shown in FIG. 7, in which the unit cell HCB is rectangular. Four sets of audio data WV1, WV2, WV3 and WV4 respectively correspond to coordinates being morphed C, D, A and B, which are pointed out by the vertexes of the rectangular unit cell. Those sets of audio data are set to reflect the four types of emotions of the same person, which emotions are defined in the two-dimensional emotional plane MSP expressing both the mental activation level and the pleasantness degree.

As stated before, the two-dimensional emotional plane MSP has the four quadrants that express delight, anger, sorrow and pleasure, respectively. Thus it is true that the more the distance from the origin in the plane, the higher the mental condition of each of delight, anger, sorrow and pleasure inherent to the respective quadrants even for the same vocabulary. Higher metal conditions are strongly reflected in the speaker's accents and/or loud voices. The origin O shows a neutral mental condition with less emotional characteristics.

In the same way as that in FIG. 7, in cases where the unit cell HCB is set to spread over the four quadrants, four types of uttered contents corresponding respectively to the typical four types of emotions of the same speaker can be mapped, as audio data WV1, WV2, WV3 and WV4, at the coordinates being morphed C, D, A and B. When a user uses the input device 57 to give the apparatus a desired morphing-destination coordinate pₓ that expresses a desired emotional state in the two-dimensional emotional plane MSP. In response to the user's input information, the desired morphing-destination coordinate pₓ is defined. In the similar algorithm to that for the foregoing image morphing (refer to FIGS. 3A-3C), the audio data WV1, WV2, WV3 and is WV4 are polymorphed, thus freely and easily synthesizing the audio data so as to be dependent on the desired emotional state. The synthesized audio data are outputted by the speaker 62 via the audio synthesis device 61.

For instance, using a morphing-destination coordinate pₓ being inputted in common for both the image and audio polymorphing, both processes for the image and audio polymorphing are carried out in parallel with each other, and both morphed results are outputted in sync with each other. This makes it possible to realize an anthropomorphic agent who provides facial expressions and uttering contents which are mutually associated depending on information of the inputted morphing-destination coordinate pₓ.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A method of polymorphing 2^{M}-sets of model data strings being morphed (M is a positive integer and M≧2), comprising steps of:
acquiring the model data strings by defining at least 2^{M}-piece coordinates being morphed in a M-dimensional model-data mapping space and making the defined model data strings correspond to the coordinates being morphed, respectively;
setting a unit cell in the model-data mapping space, the unit cell consisting of a hyper rectangular parallelepiped having 2^{M}-piece vertexes each located at the coordinates being morphed;
selecting a desired coordinate, as a morphing-destination coordinate, within the unit cell;
polymorphing the 2^{M} sets of model data strings corresponding, set by set, to the coordinates being morphed using weighting factors depending on distances from the respective coordinates being morphed to the morphing-destination coordinate in the unit cell, so that a string of synthesized data corresponding to the morphing-destination coordinate is produced; and
outputting the string of synthesized data using an outputting device.

2. The method of claim 1, comprising steps of:
producing 2^{M}-piece partial rectangular parallelepipeds by sectioning the ultras-rectangular parallelepiped using M-piece planes which are parallel to respective planes of the hyper rectangular parallelepiped and which passé the morphing-destination coordinate, each of the partial rectangular parallelepipeds i) having the morphing-destination coordinate in common and ii) exclusively having one of the coordinates being morphed located at the vertexes of the hyper rectangular parallelepiped,
wherein the weighting factors used in the polymorphing step are defined by a relative volume of each of the partial rectangular parallelepipeds to the hyper rectangular parallelepiped, wherein the relative volume of each of the partial rectangular parallelepipeds is given as a weighting factor to an diagonally located coordinate being morphed in the hyper rectangular parallelepiped.

3. The method of claim 1, wherein the model-data mapping space is two-dimensional and the unit cell is rectangular.

4. The method of claim 3, wherein the polymorphing step comprises
a step of producing a pair of in-between data strings by first-order morphing the model data strings corresponding to the coordinates being morphed located at both ends of each edge of the rectangular unit cell, using the weighing factors obtained from a relationship of a leverage that uses an equinoctial point defined by orthogonally projecting the morphing-destination coordinate to each of a pair of mutually parallel edges of the rectangular unit cell; and
a step of producing the synthesized data string by second-order morphing the pair of in-between data strings, using the weighting factors obtained form a relationship of a leverage that uses a further equinoctial point defined by regarding the morphing-destination point as the further equinoctial point located on a segment connecting both the orthogonally projected points.

5. The method of claim 1, wherein the model data strings are image data strings.

6. The method of claim 1, wherein the model data strings are audio data strings.

7. The method of claim 2, wherein the model-data mapping space is two-dimensional and the unit cell is rectangular.

8. The method of claim 7, wherein the polymorphing step comprises
a step of producing a pair of in-between data strings by first-order morphing the model data strings corresponding to the coordinates being morphed located at both ends of each edge of the rectangular unit cell, using the weighing factors obtained from a relationship of a leverage that uses an equinoctial point defined by orthogonally projecting the morphing-destination coordinate to each of a pair of mutually parallel edges of the rectangular unit cell; and
a step of producing the synthesized data string by second-order morphing the pair of in-between data strings, using the weighting factors obtained form a relationship of a leverage that uses a further equinoctial point defined by regarding the morphing-destination point as the further equinoctial point located on a segment connecting both the orthogonally projected points.

9. The method of claim 8, wherein the model data strings are image data strings.

10. The method of claim 8, wherein the model data strings are audio data strings.

11. An apparatus for polymorphing 2^{M}-sets of model data strings being morphed (M is a positive integer and M≧2), comprising steps of:
acquiring means for acquiring the model data strings by defining at least 2^{M}-piece coordinates being morphed in a M-dimensional model-data mapping space and making the defined model data strings correspond to the coordinates being morphed, respectively;
setting means for setting a unit cell in the model-data mapping space, the unit cell consisting of a hyper rectangular parallelepiped having 2^{M}-piece vertexes each located at the coordinates being morphed;
selecting means for selecting a desired coordinate, as a morphing-destination coordinate, within the unit cell;
polymorphing means for polymorphing the 2^{M} sets of model data strings corresponding, set by set, to the coordinates being morphed using weighting factors depending on distances from the respective coordinates being morphed to the morphing-destination coordinate in the unit cell, so that a string of synthesized data corresponding to the morphing-destination coordinate is produced; and
outputting means for outputting the string of synthesized data using an outputting device.
